(19) United States
(12) Patent Application Publication
(10) Pub. No.: US 2007/0099465 A1
(43) Pub. Date: May 3, 2007

(54) Assembly for a steering system of a motor vehicle

(75) Inventor: Christian Ruetz, Ludwigsburg (DE)

Correspondence Address: DREISS, FUHLENDORF, STEIMLE & BECKER, POSTFACH 10 37 62, D-70032 STUTTGART, DE

(73) Assignee: VALEO SCHALTER UND SENSOREN GMBH, Bietigheim-Bissingen (DE)

(21) Appl. No.: 11/589,391

(22) Filed: Oct. 30, 2006

(30) Foreign Application Priority Data
Nov. 3, 2005 (DE) 10 2005 053 183.0

(51) Int. Cl. H01R 3/00

(52) U.S. Cl. 439/164

(57) ABSTRACT

The disclosure relates to an assembly for a steering system of a motor vehicle, comprising an integrated support (38) on which a steering wheel hub (70) of a steering wheel (30) is rotatably mounted, wherein a rotor element (4) is provided for mounting the steering wheel hub (70) of the steering wheel (30) on the support (38).

### CROSS-REFERENCE TO RELATED APPLICATIONS

This application claims the benefit of DE 10 2005 053 183.0 filed Nov. 3, 2005. The disclosure of the above application is incorporated herein by reference.

### FIELD

The present disclosure relates to an assembly for a steering system of a motor vehicle, comprising an integrated support on which a steering wheel hub of a steering wheel is pivoted.

### BACKGROUND

The statements in this section merely provide background information related to the present disclosure and may not constitute prior art.

An assembly of this type is known from U.S. Pat. No. 3,744,817. The assembly disclosed there uses ball bearings or tapered roller bearings to allow a smooth rotation of the steering wheel about the stationary support.

### SUMMARY

It is the object of the present disclosure to create an assembly for a steering system of a motor vehicle, which is particularly easy to mount.

This object is achieved according to the disclosure in that a rotor element is provided for mounting the steering wheel hub of the steering wheel on the support. The rotor element allows a particularly flexible installation of the assembly. As a result, the rotor element can serve not only the accommodation of the steering wheel, but also the accommodation of further components, as will be described hereinafter.

The accommodation of further components is particularly facilitated when the rotor element is configured substantially in a sleeve shape. The sleeve-shaped rotor element can be used, for example, to arrange an elastic element. The rotor element and the steering wheel hub of the steering wheel can be mutually connected such that a rotation angle offset becomes possible between the rotor element and the steering wheel hub of the steering wheel. An elastic element of this type is described in the simultaneously submitted German patent application “Vorrichtung für ein Lenksystem eines Kraftfahrzeugs” [Device for a Steering System for a Motor Vehicle] (German patent application number: 10 2005 053 181.4) by the same applicant. The disclosure of this application is hereby referred to and incorporated by reference in its entirety.

The rotor element can also be designed, for example, to accommodate a gearbox element, such as a gear wheel, which is part of a gearbox for transmitting the rotations of the steering wheel onto a steering shaft. The greater the number of components that the rotor element can accommodate, the more complex and the larger the sub-assembly group can be, which can be provided for the motor vehicle for final assembly. This makes it possible to subject these complex sub-assembly groups to comprehensive quality controls, particularly to be able to precisely inspect the individual functions of the sub-assembly group. During final assembly of the motor vehicle and the subsequent final control, time can then be saved.

According to an advantageous further development of the disclosure, the steering wheel and/or the steering wheel hub is non-rotatably connected to a first coding element, which is part of a rotation angle sensor arrangement and/or a torque sensor arrangement. Accordingly, the rotor element can be designed to accommodate a second coding element, which is part of a rotation angle sensor arrangement and/or torque sensor arrangement. This arrangement of the coding elements allows a space-saving integration of a rotation angle sensor and/or of a torque sensor in an assembly close to the steering wheel. This is also described in the simultaneously submitted German patent application by the same applicant with the title “Vorrichtung zur Anordnung in einem Lenksystem eines Fahrzeugs” [Device for Arrangement in a Steering System of a Motor Vehicle] (German patent application number: DE 10 2005 053 180.6). The disclosure of this application is hereby referred to and incorporated by reference in its entirety.

An advantageous further development of the disclosure provides that an air bag unit is attached to the support such that it is decoupled from the rotation of the steering wheel. This has the advantage that the air bag unit can be fixed, so that it does not have to be designed rotation-symmetrically in order to act optimally during an accident. A fixed or “static” air bag unit also has the advantage that the use of a clock spring for the electrical contact to the air bag unit is not required. The fixed electrical contact, comprising plugs and lines for example, makes the air bag unit particularly safe during operation.

If the air bag unit has a retainer plate for arrangement of the air bag, which has an aperture for a free end of the support, the air bag unit can be fastened to the integrated support particularly simply, for example by pressing it on.

The assembly according to the disclosure may comprise a steering column switch unit with at least one steering column switch and a switch housing. The complexity of the assembly can be increased by integrating these components, thus facilitating final assembly of the motor vehicle.

The switch housing can also be designed to accommodate a circuit board and/or a clock spring. This is also described in the above-mentioned application “Vorrichtung für ein Lenksystem eines Kraftfahrzeugs” [Device for a Steering System for a Motor Vehicle].

The switch housing and/or the circuit board can be designed to accommodate stationary sensors of a torque sensor and/or of a rotation angle sensor.

The switch housing can be positioned on a component that is integrated on the vehicle body and at the same time be secured against twisting. This makes the installation of the switch housing particularly simple. The switch housing, however, can also be positioned by means of the rotor element and/or the steering wheel hub and/or the steering wheel, at least indirectly, and it can be secured against twisting on a component that is integrated on the vehicle body. This way, the switch housing can be positioned within tight tolerances relative to the rotor element and/or the steering wheel hub and/or the steering wheel, so that particularly the precise arrangement of coding elements of torque sensors and/or rotation angle sensors is facilitated. The component that is integrated on the vehicle body may be formed, for example, by the support and/or by a jacket tube surrounding the steering shaft.

The assembly may also include a drive, which drives the rotor element. Such a drive makes it possible, for example, to vary the resistance at which the steering wheel can be rotated, so that the driver of the motor vehicle can receive feedback about certain dynamic conditions of the motor vehicle. It is also possible that the drive performs or supports the motion of the steering wheel in a direction proposed by a driver assistance system.

The assembly can be used for a conventional steering system, wherein the motion of the steering wheel is transmitted mechanically to the motion of a steering shaft. The assembly can, however, also be provided for a steer-by-wire steering system.

The disclosure also relates to different methods for the installation of an assembly for a steering system of a motor vehicle.

Additional advantages, characteristics, and details of the present disclosure will be apparent from the description, in which with reference to the drawing a particularly preferred embodiment is described in detail. The characteristics illustrated in the drawing and mentioned in the claims as well as in the description can be essential for the disclosure either alone or in any random combination.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way. The figures show:

FIG. 1 a perspective view of an assembly according to the disclosure in a sub-assembly state;

FIG. 2 a section of the assembly according to the disclosure in a complete installation state; and

FIGS. 3 and 4 detailed views of the assembly.

### DETAILED DESCRIPTION

The following description is merely exemplary in nature and is not intended to limit the present disclosure, application, or uses.

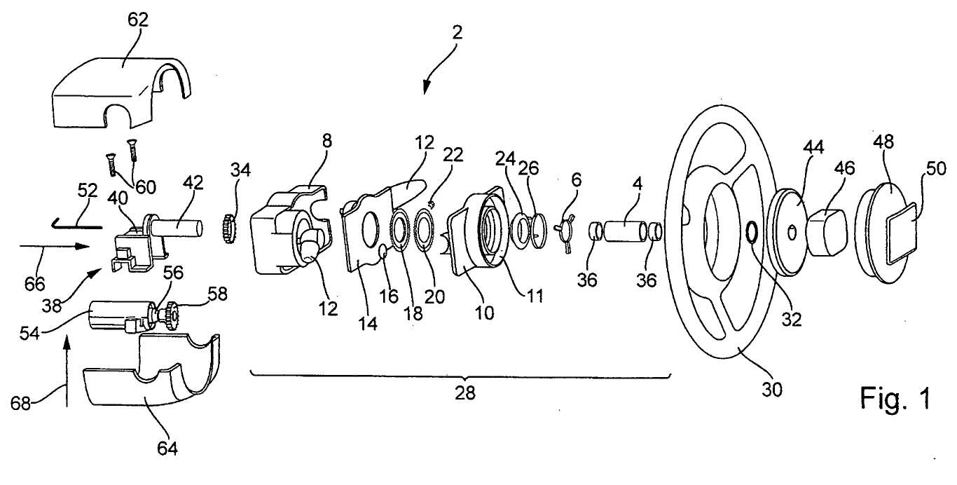

In FIG. 1, an assembly according to the disclosure has been given the overall reference numeral 2. It comprises a hollow cylindrical rotor element 4. The rotor element 4 can be connected torque proof to an elastic element 6, which will be explained in detail with reference to FIG. 4.

To the left of the elastic element 6, the bottom part 8 and the top part 10 of a switch housing are illustrated. The top part 10 of the switch housing has a ring-shaped chamber 11 for a clock spring, which is not shown, facing away from the bottom part 8 of the switch housing. The switch housing serves, among other things, the accommodation of two steering column switches 12. A circuit board 14, which in turns serves for the arrangement of a rotational speed sensor 16, can be inserted in the bottom part 8 of the switch housing 8 [sic]. The sensor 16 can be used to record the number of full steering wheel revolutions of a steering wheel 30.

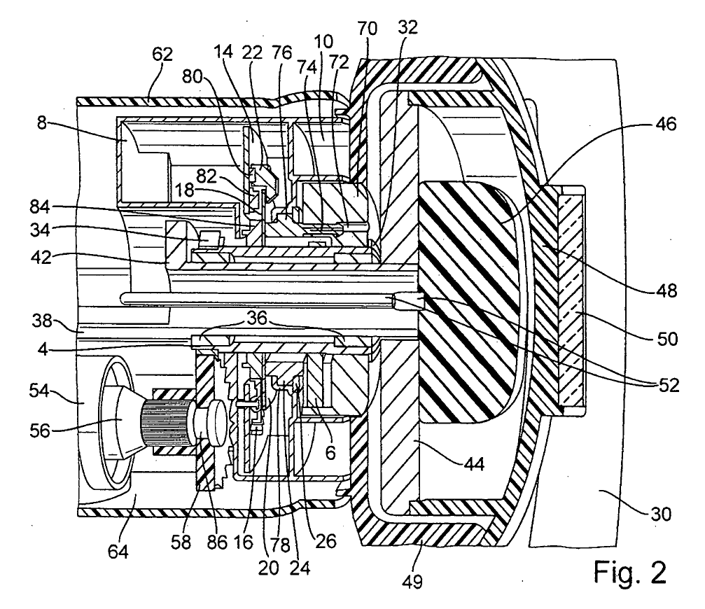

Inside the switch housing, a second coding element 18 may be provided, which is part of a torque sensor. Parallel to the second coding element 18, a first coding element 20 can be provided, which is part of a rotation angle sensor. The coding elements 18 and 20 are associated with a light guide element 22, the function of which will still be described with reference to FIG. 2.

The first coding element 20 is fastened to a retainer ring 24, which is illustrated to the right of the top part 10 of the switch housing. A bearing ring 26 is provided for positioning the retainer ring 24 on the top part 10 of the switch housing.

The components 8 to 26 form an assembly group 28, which can be slid onto the rotor element 4. Accordingly, the steering wheel 30 can be placed on the rotor element 4, where it is mounted rotatably about the rotor element 4 and can be secured in the axial direction by means of a circlip 32. After placing the assembly group 28 on the rotor element 4, a gearbox element 34 configured as a gear wheel can be placed on the rotor element 4 and connected torque proof thereto.

The assembly configured this way, which comprises all the parts 4 to 34 mentioned above, can be placed together with the rotor element 4 and with the help of two roller bearings 36 onto a support 38 that is integrated on the vehicle body. The support 38 has a base region 40 as well as a cylindrical section 42. It is dimensioned such that the roller bearings 36 may be disposed thereon, so that the rotor element 4 is mounted rotatably on the section 42.

The cylinder section 42 has such a length that a retainer plate 44 can be placed on the free end penetrating the steering wheel 30 and that it can be connected torque proof to the cylindrical section 42. On the retainer plate 44, an air bag 46 is provided, which just like the retainer plate 44 and the cylindrical section 42 as well as the support 38, is not coupled for rotation with the steering wheel 30, thus is fixed. A cover 48 covers the air bag 46, which cover likewise does not rotate along with the steering wheel 30, so that a monitor 50 provided on the cover 48 remains in the position illustrated in FIG. 1 even when the steering wheel 30 turns.

Alternatively to the arrangement described above, the cover 48 may also not be connected to the retainer plate 44, but instead to the steering wheel 30 (for example the ring-shaped base body 49 of the steering wheel 30). As a result, the cover 48 rotates jointly with the steering wheel. The cover 48 may be provided with operator elements such as switches, knurling wheels etc., which then rotate jointly with the cover 48—in an ergonomically advantageous manner. The operator elements can be electrically contacted with the help of the above-mentioned clock spring.

The electric contact to the air bag 46 can be established with the help of an electrical contact 52, which penetrates the hollow cylindrical section 42.

The support 38 may be placed with its base region 40 on complementarily designed mounts on the integrated jacket tube 54. The jacket tube 54 serves the mounting of a steering shaft 56, which has a gear wheel 58 on its free end, which is configured for a combing engagement with the gearbox element 34. The support 38 can be connected to the corresponding mounts of the jacket tube 54 with the help of two fastening elements 60, which penetrate the base region 40 of the support.

So as to protect the components described above and illustrated in FIG. 1 to the left of the steering wheel 30, an upper steering column housing 62 and a lower steering column housing 64 are provided.

The assembly 2 is particularly easy to install. This is also due to the fact that essentially only two joining directions are required for installation. For one, this is the joining direction 66 extending coaxially to the steering axis of the steering wheel 30 and secondly the joining direction 68 extending perpendicularly thereto.

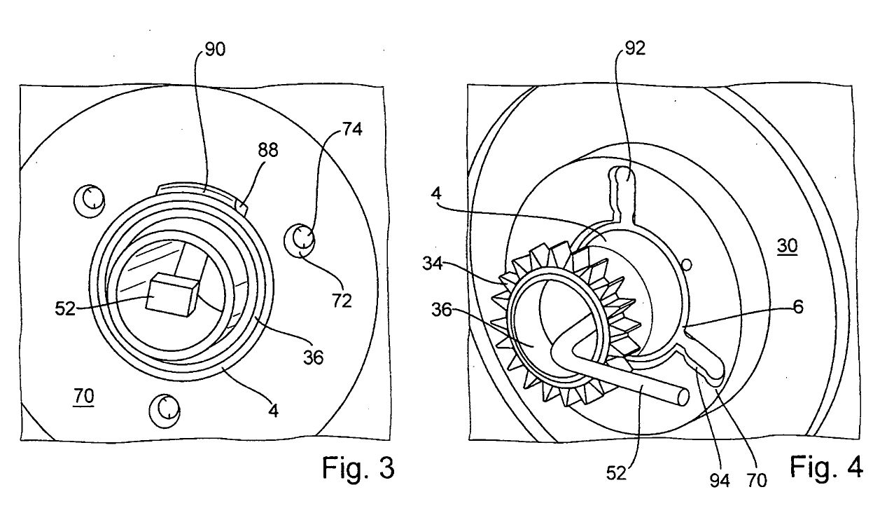

FIG. 2 illustrates a section of the mounted assembly 2. It is apparent that the steering wheel 30 has a central steering wheel hub 70, which can rotate in relation to the rotor element 4. The steering wheel hub 70 comprises a total of three journal mounts 72, which are also shown in FIG. 3. Journals 74, which are configured as one piece with the retainer ring 24, protrude into the journal mounts 72. The retainer ring 24 comprises radially on the outside an annular collar 76. The collar 76 slides into a bearing section 78, which is configured on the top part 10 of the switch housing. Furthermore, the collar 76 is fixed in the axial direction with the help of a circlip 26. As a result of the mount described above, the steering wheel 30 can rotate and the first coding element 20 connected to the retainer ring 24 can rotate via the journals 74 and the retainer ring 24.

Adjacent to the first coding element 20, the circuit board 14 is disposed inside the bottom part 8 of the switch housing. A light-emitting diode 80 is disposed thereon, which conducts light across the light guide element 22 back towards a photoreceiver 82, which is likewise disposed on the circuit board 14. Codings (which may be configured for example as segment-shaped apertures) of the first coding element 20 may penetrate through the free space formed between the light guide element 22 and the photoreceiver 82, so that the photoreceiver 82 receives the corresponding light signals subject to the rotation angle position of the steering wheel 30.

The second coding element 18 is disposed parallel to the first coding element 20, the codings (which may be configured for example as segment-shaped apertures) of which second element may also produce or interrupt the light beam between the light guide element 22 and the photoreceiver 82. The second coding element 18 is mounted on a retainer ring 84, which is in turn connected torque proof to the rotor element 4. The retainer ring 84 comprises radially outside a tooth system, which interacts with a corresponding tooth system of the rotational speed sensor 16.

Upon rotation of the rotor element 4, the gearbox element 34 rotates, which in turn drives the gear wheel 58. The gear wheel is connected to the steering shaft 56 via a screw 86.

The rotational motion of the steering wheel 30 is transmitted to the rotor element 4 by means of the elastic element 6, which is also illustrated in FIG. 4. The elastic element 6 has a total of three elastic-bending sections 92, which extend in the radial direction and are received without play in corresponding grooves 94, which are configured in the steering wheel hub 70. Upon rotation of the steering wheel 30, the steering wheel hub 70 rotates, wherein the elastic-bending sections 92 of the elastic element 6 are driven via the grooves 94. The rotor element 4 is driven by the torque proof connection to the elastic element 6.

The elastic-bending sections 92 allow mutual angular offset of the steering wheel 30 and the rotor element 4 when correspondingly high torque is applied on the steering wheel 30. So as to protect the elastic element from overloads, the rotor element 4 according to FIG. 3 has a cam 90 on its outer circumference, which cam engages in a groove 88 formed in the steering wheel hub 70. The groove 88 is dimensioned such that the cam 90 can rotate by +/−7° relative to the groove 88.

The maximum angular offset of +/−7° is greater than the maximum angular offset that has to be measured; this one is +/−4°, for example.

The rotational motion of the steering wheel 30 can also be transmitted directly onto the rotor element 4, i.e., without use of an elastic element 6. For such an arrangement, and also for the described arrangement, the interposition of the gearbox elements 34 and 58 results in a reversal in the rotational direction between the steering wheel 30 and the steering shaft 56. This reversal can again be reversed by a suitable configuration of the downstream steering gear, for example in that the steering shaft in the installation position combs from beneath with the gear rod of the steering gear

What is claimed is:

1. An assembly for a steering system of a motor vehicle, comprising an integrated support on which a steering wheel hub of a steering wheel is rotatably mounted, characterized in that a rotor element is provided for mounting the steering wheel hub of the steering wheel on the support.

2. An assembly according to claim 1, characterized in that the rotor element is designed substantially with a sleeve shape.

3. An assembly according to claim 1, characterized in that the rotor element and the steering wheel hub of the steering wheel are mutually connected via an elastic element allowing rotation angle offset.

4. An assembly according to claim 1, characterized in that the rotor element is configured to accommodate a gearbox element, which is part of a gearbox for transmitting the rotational motion of the steering wheel to a steering shaft.

5. An assembly according to claim 1, characterized in that the steering wheel and/or the steering wheel hub are connected torque proof to a first coding element, which is part of a rotation angle sensor arrangement and/or torque sensor arrangement.

6. An assembly according to claim 1, characterized in that rotor element is configured to accommodate a second coding element, which is part of a rotation angle sensor arrangement and/or torque sensor arrangement.

7. An assembly according to claim 1, characterized in that an air bag unit is fastened to the support such that the unit is decoupled from the rotation of the steering wheel.

8. An assembly according to claim 7, characterized in that the air bag unit has a retainer plate for arranging the air bag, which plate has an aperture for a free end of the support.

9. An assembly according to claim 1, characterized in that the assembly includes a steering column switch unit, which has at least one steering column switch and a switch housing.

10. An assembly according to claim 9, characterized in that the switch housing is configured to accommodate a circuit board and/or a clock spring.

11. An assembly according to claim 9, characterized in that the switch housing and/or the circuit board are configured to accommodate stationary sensors of a torque sensor and/or a rotation angle sensor.

12. An assembly according to claim 9, characterized in that the switch housing is positioned on a component that is integrated on the vehicle body and secured against twisting.

13. An assembly according to claim 9, characterized in that the switch housing is positioned at least indirectly by the rotor element and/or the steering wheel hub and/or the steering wheel and is secured against twisting on a component that is integrated on the vehicle body.

14. An assembly according to claim 12, characterized in that the component that is integrated on the vehicle body is formed by the support and/or by a jacket tube surrounding the steering shaft.

15. An assembly according to claim 1, characterized in that the assembly includes a drive, which drives the rotor element.

16. An assembly according to claim 1, characterized in that the assembly is provided for a steer-by-wire steering system.

17. A method for installing an assembly for a steering system of a motor vehicle, comprising:
forming a first assembly by joining at least one of a steering column switch unit, at least one coding element of a rotation angle sensor arrangement, and a torque sensor arrangement with a rotor element;
joining at least a steering wheel to at least one of the first assembly and the rotor element; and
joining the rotor element with an integrated support.

18. A method for installing an assembly according to claim 17, characterized in that the rotor element is joined with a gearbox element.

19. A method for installing an assembly according to claim 17, characterized in that an air bag unit is inserted in the steering wheel and joined with the integrated support.

20. A method for installing an assembly according to claim 17, characterized in that the assembly is joined with a gearbox for transmitting the rotational motion of the steering wheel to a steering shaft.
